(19) United States
(12) Patent Application Publication
(10) Pub. No.: US 2013/0054100 A1
(43) Pub. Date: Feb. 28, 2013

(54) METHOD FOR OPERATING AN ENGINE

(71) Applicants: Martin GIENCKE, Frankfurt (DE); Norbert KAISER, Bad Soden (DE)

(72) Inventors: Martin GIENCKE, Frankfurt (DE); Norbert KAISER, Bad Soden (DE)

(73) Assignee: GM GLOBAL TECHNOLOGY OPERATIONS LLC, Detroit, MI (US)

(21) Appl. No.: 13/589,240

(22) Filed: Aug. 20, 2012

(30) Foreign Application Priority Data
Aug. 20, 2011 (DE) 10 2011 111 226.3

(51) Int. Cl. B60W 10/06

(52) U.S. Cl. 701/54; 477/90

(57) ABSTRACT

A method is provided for operating an engine that includes, but is not limited to checking if a clutch pedal is depressed. If this is the case, the setpoint value for the rotational speed is predetermined to a target idle speed and a target torque is predetermined. Following this it is checked if the clutch pedal is in a position in which it is no longer depressed, and if the neutral gear sensor indicates that a gear is engaged. If this is the case, the setpoint value of the rotational speed of the engine and/or the torque reserve are increased. Otherwise, the setpoint value of the rotational speed of the engine and the torque are left.

### CROSS-REFERENCE TO RELATED APPLICATION

This application claims priority to German Patent Application No. 10 2011 111 226.3, filed Aug. 20, 2011, which is incorporated herein by reference in its entirety.

### TECHNICAL FIELD

The technical field relates to a method for operating an engine of a vehicle and a control device.

### BACKGROUND

In the case of vehicles with manual transmission, a driver has to actuate the accelerator pedal and the clutch pedal in a coordinated manner such that the engine neither revs up nor is stalled. DE 10 2006 025 178 A1 describes a start-up assistance. For assisting the driver, a torque reserve is increased by changing the throttle valve opening. However, this measure can also lead to increased fuel consumption.

In view of the foregoing, at least one object to provide a method for activating an engine of a vehicle and a vehicle drive, with which a reduction of fuel consumption is made possible. In addition, other objects, desirable features, and characteristics will become apparent from the subsequent summary and detailed description, and the appended claims, taken in conjunction with the accompanying drawings and this background.

### SUMMARY

A method is provided for operating an engine of a vehicle. The vehicle comprises a clutch pedal and a manual transmission with a neutral gear sensor. The neutral gear sensor is equipped for indicating whether a gear is engaged or whether the manual transmission is shifted to neutral. The method comprises the following steps. It is checked if the clutch pedal is in a position, where it is depressed. Following this it is checked if the clutch pedal is in a position in which it is no longer depressed and if the neutral gear sensor indicates that a gear is engaged. If the preceding checking step indicates that the clutch pedal is no longer depressed and that the neutral gear sensor indicates that a gear is engaged, the setpoint value of the rotational speed of the engine is increased above the idle speed and/or the torque reserve increased above the idle torque reserve. Otherwise, the setpoint value of the rotational speed of the engine and the torque reserve are left. The idle speed is the speed that that is predetermined with fully depressed pedal. Accordingly, the idle torque reserve is the torque reserve which is set with fully depressed clutch pedal. For example, the idle speed in normal operation is 680 revolutions per minute. This idle speed however does not need to be a fixed value, it can slightly vary with the consumption. If the air conditioner of the vehicle consumes much energy, the idle speed in the mentioned example can then amount to approximately 750 revolutions per minute.

By checking if a gear is engaged it is prevented that the rotational speed of the engine is also increased when the gear shift is in a neutral position. Since increasing the rotational speed or the increasing of the torque reserve increases the fuel consumption, it is advantageous that this only takes place when in fact a gear is engaged. Only when a gear is engaged is there the risk that the engine stalls when the pressure on the clutch pedal is reduced.

The stated method can be used with vehicles employing drive by wire and in particular break by wire. The method is suitable in particular with vehicles, which for example because of a built-in start-stop automatic, already have a neutral gear sensor. The output signal of the neutral gear sensor is used for the engine control and can thus also be utilised in order to influence the increasing of the rotational speed of the predetermined torque reserve at idle speed.

In an embodiment, the ignition is set to more retarded ignition angles for increasing the torque reserve and the amount of air sucked into the engine is increased. By doing so, torque can be made available quickly for start-up. Increasing the torque reserve can for example be effected by changing the position of the throttle valve. By increasing the quantity of the sucked-in air and adjusting the ignition angle, the torque reserve can be increased in order to assist the start-up without stalling the engine.

In this embodiment, the ignition is moved to retard and the throttle valve opened simultaneously. On the clutch, this is initially moment-neutral but results in that in the case of a spark-ignition engine a large torque jump can be generated if required from one combustion to the next. The rotational speed is likewise increased only when the clutch pedal is lifted again. The rotational speed increase and the torque reserve are triggered simultaneously as a rule.

Preferentially, the method includes an additional step of reducing the setpoint value of the rotational speed of the engine in the case that during a check it was determined that the clutch pedal is depressed again. Depressed clutch pedal in this case is to mean that it does not necessarily have to be depressed as far as to the stop. It is sufficient that the clutch pedal is largely depressed, i.e., that the clutch pedal position has exceeded a threshold value which is near the stop of the clutch pedal. During the step of checking as to whether the clutch pedal is in a position in which it is no longer depressed, it is checked in this embodiment if the clutch pedal is located outside a lower pedal range.

The application also relates to a control device for activating an engine of a vehicle on start-up. Here, the vehicle comprises an engine, a clutch pedal and a manual transmission with a neutral gear sensor for indicating either if a gear is engaged or if the manual transmission is in neutral. The control unit includes a first checking unit for checking if the clutch pedal is in a position wherein the clutch pedal is depressed. It additionally includes a target setting for setting a setpoint value of the rotational speed and for setting the torque reserve of the engine. Here, the target setting is equipped for setting the setpoint value to an idle speed and the torque reserve to an idle torque reserve in the case that the first checking device indicates that the clutch pedal is depressed.

A second checking device is equipped for checking if the clutch pedal is in a position, in which it is no longer depressed, and if the neutral gear sensor of the vehicle indicates that a gear is engaged. The target setting is equipped for increasing the setpoint value of the rotational speed and/or of the torque reserve of the engine, in the case that the second checking unit indicates that the clutch pedal is no longer depressed, and that the neutral gear sensor indicates that a gear is engaged, and otherwise for leaving the setpoint value of the rotational speed of the engine and the torque reserve. The control unit makes it possible that with neutral gear the rotational speed and/or the torque reserve of the engine is not increased, by which fuel is saved.

In an embodiment, the target setting is equipped for increasing the torque reserve for setting the ignition angle to retarded ignition angles. In addition, the target setting is equipped for increasing the torque reserve by increasing the quantity of air sucked into the engine. The target setting can also be equipped for increasing the quantity of the sucked-in air by requesting an enlargement of the opening of a throttle valve.

In an embodiment, the target setting is equipped for reducing the setpoint value of the rotational speed in the case that the setpoint value of the rotational speed is above the predetermined idle speed and it was determined by the second checking device that the position of the clutch pedal has again exceeded an upper threshold. In this case, the rotational speed of the engine can be returned again to the idle speed, since the driver obviously does not start-up after all, but merely has taken back the clutch pedal for a short time.

For checking if the clutch pedal is in a position in which it is no longer depressed, the checking device is equipped in such a manner that it checks if the position of the clutch pedal is outside a predetermined lower range. Finally, the application also relates to a vehicle having such a control device.

With the method and the control device it can be prevented that a large torque reserve or a large rotational speed is built up when the driver, without having engaged a gear, only briefly releases the clutch pedal or relieves said clutch pedal in a middle range. This is achieved in that information which is provided by a neutral gear sensor is taken into account. When the neutral gear sensor indicates that a gear is engaged and the driver has released the clutch to just before the slipping point, the torque reserve or the rotational speed is increased. In the same manner, additional assistance functions can be additionally switched on exactly when these are required.

With this method, the torque reserve can be increased up to full throttle in that for example the ignition is retarded and the air mass flow is increased. This serves for making the start-up as pleasant as possible for the driver. It is possible to activate additional functions in this manner without losing efficiency by generating torque reserve or a higher rotational speed, since the functions are only activated when needed.

The application also relates to a computer program, which, when it is carried out on a programmable control circuit of a vehicle, prompts the programmable control circuit to carry out the steps of one of the methods described above. The application also relates to a data memory having such a computer program.

### BRIEF DESCRIPTION OF THE DRAWINGS

The present invention will hereinafter be described in conjunction with the following drawing figures, wherein like numerals denote like elements, and:

FIG. 1 is a circuit diagram for schematic function blocks of a vehicle in which the control unit is implemented;

FIG. 2 is signal profiles on selected points of the circuit diagram in FIG. 1;

FIG. 3 is pedal positions of a clutch pedal; and

FIG. 4 is signal profiles as a function of the clutch pedal.

### DETAILED DESCRIPTION

The following detailed description is merely exemplary in nature and is not intended to limit application and uses. Furthermore, there is no intention to be bound by any theory presented in the preceding background or summary or the following detailed description.

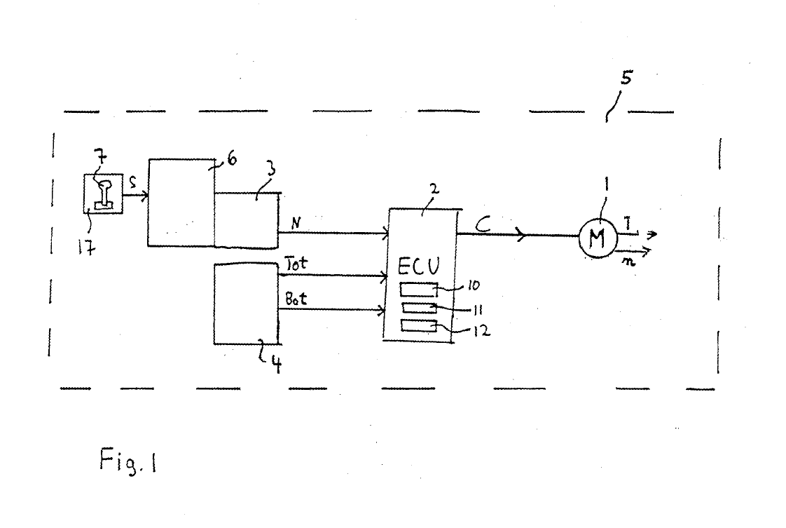

FIG. 1 schematically shows in a circuit diagram the function blocks and elements used for controlling an engine of a vehicle 5. The vehicle 5 includes an external shifting system 17 with a gear shift lever 7, a manual transmission 6, a neutral gear sensor 3, a clutch pedal 4, an engine control 2 and an engine 1.

A driver actuates the clutch pedal 4 and a gear shift lever 7. On the clutch pedal 4, at least one sensor is provided, which indicates the position of the clutch pedal 4. This sensor can be a potentiometer, which at least outputs the signals BoT and ToT. BoT indicates if the clutch pedal is depressed while ToT indicates if the clutch pedal is in its starting position. In other words, BoT shows a depressed pedal for bottom of travel, ToT a only slightly depressed clutch pedal for top of travel. If the pedal has not been touched, both values indicate the status “FALSE”. The gear shift lever 7 is connected to the manual transmission 6 via cables S or via shifting linkage.

The signal N is a pulse width-modulated square wave signal. The relationship between the impulse degree of the signal N and the position of the gear shift lever is linear in an embodiment, wherein an impulse degree of approximately 10% or approximately 90% indicates an engaged gear. With a signal of approximately 100% or approximately 0%, an error is recognised. With impulse degrees of approximately 50% or near approximately 50%, no gear is engaged. For example, the impulse degree with engaged first gear is approximately 90% and with the second gear approximately 10%. In an alternative embodiment, the relationship follows a bell shape. Here, in both gears, a value of for example approximately 10% would be indicated. Approximately 0% however in this case shows a further instance of an error.

The engine control 2 among other things receives the signals N, ToT and BoT as input signals. The engine control 2 outputs control signals C to the engine 1, which is embodied as combustion engine. These control signals C determine the ignition timing for the ignition of the combustion engine and for the opening of the throttle valve. The engine 1 drives an output shaft, which rotates at a rotational speed n and supplies a torque T. In the engine control 2, which serves as control unit for the engine, the function blocks which serve for carrying out the method, are realised as a first checking unit 10, a target setting 11 and a second checking unit 12.

The first checking unit 10 serves for checking if the clutch pedal 4 is in a position in which the clutch pedal is depressed, and the target position 11 serves for predetermining the setpoint value of the rotational speed of the engine and the second checking unit 12 for checking if the clutch pedal is in a position in which it is no longer depressed, and if the neutral gear sensor 3 of the vehicle indicates that a gear is engaged. The function blocks can be realised in different ways. It is possible for example to realise these in separate circuits. However, they can also be implemented in a micro controller as program instruction routines.

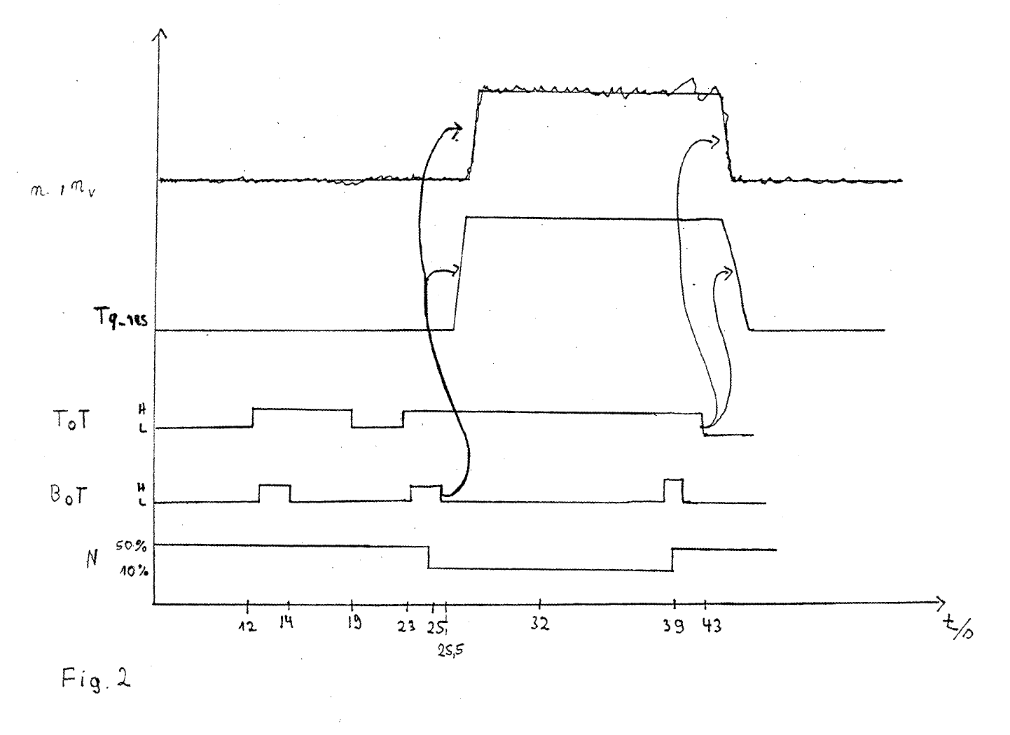

FIG. 2 shows signals on selected points from FIG. 1 over the time t. In FIG. 2, the rotational speed n and the rotational speed target nV are drawn in at the top. There, the target of the rotational speed nV is drawn in with smooth lines, while the curve of the actual rotational speed n of the engine 1 follows a more irregular course, but substantially follows the rotational speed target nV. The second diagram shows the torque reserve Tq of the engine. The third diagram shows the curve of the signal ToT, the fourth diagram the curve of the signal BoT and the fifth diagram drawn in at the bottom, the signal N output by the neutral gear sensor.

In the period from 0 seconds to 25 seconds (s), no gear is engaged, upon which the signal N has an impulse degree of approximately 50%. At 12 s, the driver starts to depress the clutch pedal and holds it fully depressed up to the time of 14 s. From 14 s to 19 s, the clutch pedal is in a middle position. At 19 s, the driver completely releases the clutch pedal again. At 23 s he again depresses the clutch pedal. In the time from 0 s to 25 s, nothing changes with respect to the predetermined rotational speed, with respect to the actual rotational speed and with respect to the torque reserve, since the manual transmission is in neutral.

At 25 s, the driver engages a gear so that the signal N now jumps to approximately 10%. Following this, at 25.5 s, the driver slightly releases the clutch pedal again, so that it is again in a middle position. The falling edge of the BoT signal causes the rotational speed target nV and the actual rotational speed N as well as the torque reserve Tq to increase. Increasing the torque reserve Tq and the rotational speed N is effected in that the engine control carries out a further opening of the throttle valve and the adjusting of the ignition angle towards retarded. The actual torque on the crankshaft is not increased but merely the torque reserve. The actual torque continues to amount to approximately 0 Nm. Of course, only in principle so. It is quite probable, that the torque reserve made available is consumed or used up by the idle speed controller and thus the actual torque is increased. Merely a torque reserve is made available.

The driver leaves the clutch pedal in a middle position. As start-up assistance, the higher rotational speed and a higher torque reserve is now made available to him. On releasing the clutch pedal, the actual torque is now also increased. This is carried out in that the torque reserve is now used up. From the time 39 s, a neutral gear is again engaged. In order to bring the gear selector lever into a neutral position again, the clutch is again fully depressed in this example. To this end, the signal BoT again assumes the value “true”. Obviously, the gear can also be ripped out without clutch actuation, but which does not constitute a regular case. At 43 s, the clutch pedal is completely released, the signal ToT returns to zero. Even after the clutch has been fully released again, the rotation speed increase and the torque reserve are still held for a certain time of 3 seconds. Insofar, the decrease of the reserve and the setpoint speed after the edge change of the signal ToT at 43 s takes place in a delayed manner. The predetermined rotational speed, the actual rotational speed of the engine and the torque reserve are lowered again.

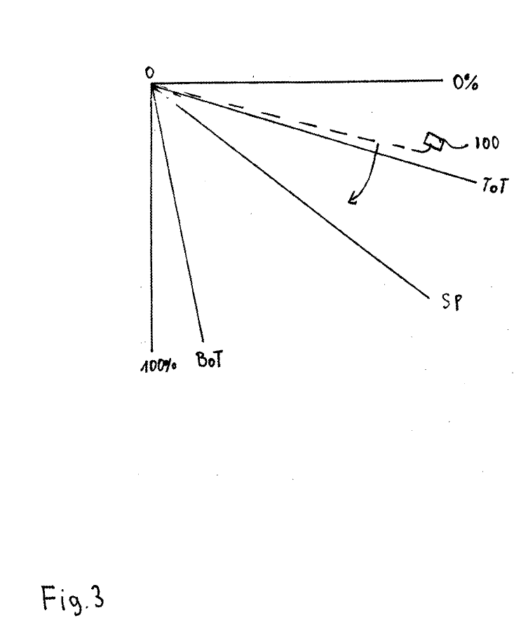

FIG. 3 shows pedal positions of the clutch pedal. A clutch pedal 100 is rotatably mounted about an origin 0. The arrow direction indicates the direction in which the clutch pedal 100 moves when it is depressed by the driver. If the driver's foot is not on the clutch pedal 100, the pedal position is approximately 0%, when he slightly depresses the pedal, it exceeds the position ToT. Approximately halfway between the released pedal and a fully depressed pedal is located the slipping point SP. If the driver depresses the pedal even further, the clutch pedal 100 exceeds the pedal position BoT. With fully depressed pedal, the pedal position is approximately 100%.

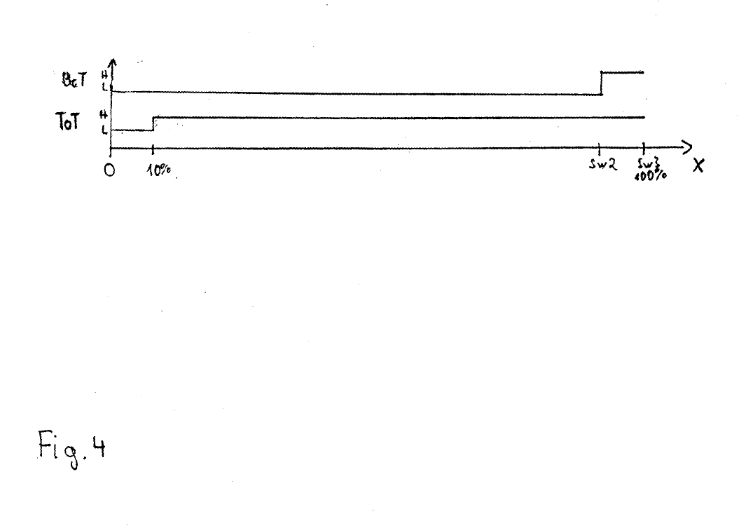

FIG. 4 shows the curve of the signals BoT and ToT as a function of the pedal position x. The signals BoT and ToT are digital signals with voltage levels, which are called high (H) and low (L). The pedal position x describes the path from a starting position, wherein the clutch pedal is in the starting position, in which the driver does not touch the clutch pedal at all. x in this case is stated in percent, as is described with respect to FIG. 3. In the starting position, i.e., the pedal is completely released, x is equal to approximately 0%.

When the clutch pedal is depressed up to the stop, it is in the position x=Sw3. The level of the signal ToT from the position x=approximately 0% is located on low and remains there up to a first threshold Sw1. The first threshold Sw1 is positioned at approximately approximately 10% of Sw3. In the case of positions x, which are greater than the first threshold Sw1, the signal level of the signal ToT is high up to the position Sw3. Thus, the signal ToT indicates, when it is positioned on low, that the clutch pedal is in the starting position or in the vicinity of the starting position.

The signal BoT is low from x=0 up to a second threshold Sw2, which is located at approximately 90% of Sw3. With pedal positions x that are greater than Sw2, the signal BoT is at high. The signal BoT thus indicates, when it is high, that the clutch pedal is depressed. When the signal level of the signal ToT is on high and the signal level of the signal BoT on low, the clutch pedal is in a middle position. In further embodiments which are not shown here, further signals can indicate the range in which the pedal positions are located. For example, a further signal could indicate a middle pedal position range.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for operating an engine of a vehicle comprising a clutch pedal and a manual transmission with a neutral gear sensor, the method comprising:
checking if the clutch pedal is pressed;
checking if the clutch pedal is in a position where the clutch pedal is no longer pressed;
checking if the neutral gear sensor of the vehicle indicates that a gear is engaged;
increasing of a setpoint value of a rotational speed of the engine above an idle speed when the preceding checking step shows that the clutch pedal is no longer depressed and that the neutral gear sensor indicates that a gear is engaged;
increasing of a torque reserve above and idle torque reserve in when the preceding checking step shows that the clutch pedal is no longer depressed and that the neutral gear sensor indicates that a gear is engaged; and
leaving the setpoint value of the rotational speed of the engine on a value of the idle speed and a target of the torque reserve on a value of the idle torque reserve.

2. The method according to claim 1, wherein the increasing of the torque reserve comprises setting an ignition angle to more retarded ignition angles and increasing a quantity of air sucked into the engine.

3. The method according to claim 2, wherein the increasing a quantity of sucked-in air comprising enlarging the opening of a throttle valve.

4. The method according to claim 1, further comprising increasing the torque reserve of the reducing of the setpoint value of the rotational speed of the engine if it is determined during a check that the clutch pedal is again depressed after the increasing of the setpoint value of the rotational speed of the engine.

5. The method according to claim 1, further comprising reducing of the torque reserve if it is determined during a check that the clutch pedal is again depressed after the increasing of the setpoint value of the rotational speed of the engine.

6. The method according to claim 1, further comprising checking if the clutch pedal is located in a predetermined middle pedal position range during the checking if the clutch pedal is in the position and the clutch pedal is no longer depressed.

7. A control device for activating an engine of a vehicle that comprises a clutch pedal and a manual transmission with a neutral gear sensor, the control device comprises:
a first checking unit that is configured to check if the clutch pedal is in a position where the clutch pedal is depressed;
a target setting that is configured to predetermine a setpoint value of a rotational speed of the engine and further configured to set a torque reserve of the engine, the target setting further configured to predetermine the setpoint value to an idle speed and predetermine an idle torque reserve if the first checking unit indicates that the clutch pedal is depressed;
a second checking unit that is configured to check if the clutch pedal is in the position, wherein the clutch pedal is no longer depressed and if the neutral gear sensor of the vehicle indicates that a gear is engaged;
wherein the target setting is equipped for increasing the setpoint value of the rotational speed of the engine for adjusting the torque reserve, if the second checking unit indicates that the clutch pedal is no longer depressed and that the neutral gear sensor indicates that a gear is engaged and otherwise for leaving the setpoint value of the rotational speed of the engine.

8. The control device according to claim 7, wherein the target setting is configured to increase the torque reserve by setting an ignition angle to more retarded ignition angles and configured to increase the torque reserve by increasing a quantity of air sucked into the engine.

9. The control device according to claim 8, wherein the target setting is configured to increase a quantity of sucked-in air for requesting an enlargement of the opening of a throttle valve.

10. The control device according to claim 7, wherein the target setting is configured to reduce the setpoint value of the rotational speed of the engine when the setpoint value of the rotational speed is above a predetermined idle speed and the second checking device detects that the clutch pedal has exceeded an upper position.

11. The control device according to claim 7, wherein the second checking unit is equipped for checking if the clutch pedal is located in the position for checking if the clutch pedal is in a predetermined middle pedal position range.

12. A computer readable medium embodying a computer program product, said computer program product comprising:
a operating program for operating an engine of a vehicle comprising a clutch pedal and a manual transmission with a neutral gear sensor, the operating program configured to:
check if the clutch pedal is pressed;
check if the clutch pedal is in a position where the clutch pedal is no longer pressed;
check if the neutral gear sensor of the vehicle indicates that a gear is engaged;
increase of a setpoint value of a rotational speed of the engine above an idle speed when the preceding checking step shows that the clutch pedal is no longer depressed and that the neutral gear sensor indicates that a gear is engaged;
increase of a torque reserve above and idle torque reserve when the preceding checking step shows that the clutch pedal is no longer depressed and that the neutral gear sensor indicates that a gear is engaged; and
leave the setpoint value of the rotational speed of the engine on a value of the idle speed and a target of the torque reserve on a value of the idle torque reserve.

13. The computer readable medium embodying the computer program product according to claim 12, wherein the increase of the torque reserve comprises setting an ignition angle to more retarded ignition angles and increasing a quantity of air sucked into the engine.

14. The computer readable medium embodying the computer program product according to claim 13, wherein the increase of a quantity of sucked-in air comprising enlarging the opening of a throttle valve.

15. The computer readable medium embodying the computer program product according to claim 12, the operating program configured to further configured to increase the torque reserve of the reducing of the setpoint value of the rotational speed of the engine if it is determined during a check that the clutch pedal is again depressed after the increasing of the setpoint value of the rotational speed of the engine.

16. The computer readable medium embodying the computer program product according to claim 12, the operating program configured to further configured to reduce of the torque reserve if it is determined during a check that the clutch pedal is again depressed after the increasing of the setpoint value of the rotational speed of the engine.

17. The computer readable medium embodying the computer program product according to claim 12, the operating program configured to further configured to check if the clutch pedal is located in a predetermined middle pedal position range during the check if the clutch pedal is in the position and the clutch pedal is no longer depressed.
